(19) United States
(12) Patent Application Publication
(10) Pub. No.: US 2026/0182587 A1
(43) Pub. Date: Jul. 2, 2026

(54) REFRIGERATED SANDWICH PRODUCT, AND DOUGH FORMULATION FOR USE IN REFRIGERATED SANDWICH PRODUCTS

(71) Applicant: Kraft Foods Group Brands LLC, Chicago, IL (US)

(72) Inventors: Isabella Mahlmann, Chicago, IL (US); Luc Casavant, Rexdale (CA); Yolande Papillon, Rexdale (CA); Keith Forneck, Rexdale (CA)

(21) Appl. No.: 19/222,297

(22) Filed: May 29, 2025

Related U.S. Application Data
(60) Provisional application No. 63/740,430, filed on Dec. 31, 2024.

(51) Int. Cl. A21D 13/32; A21D 8/04; A23B 45/10; A23L 25/10; B65D 1/36; B65D 77/20

(52) U.S. Cl. CPC A21D 13/32; A21D 8/042; A23B 45/10; A23L 25/10; B65D 1/36; B65D 77/2024

(57) ABSTRACT

A refrigerated sandwich product is provided herein. In some embodiments, the sandwich product is provided in a formed tray with one or more cavities and sealed with a lidding material, such as a flexible film. The sandwich product includes a fully baked bread product prepared with a dough including a combination of a maltogenic amylase and an amyloglucosidase. The final packaged sandwich product described herein maintains a soft crumb texture and has a refrigerated shelf life of 30 days or more.

### CROSS-REFERENCE TO RELATED APPLICATION

This application claims the benefit of U.S. Provisional Application No. 63/740,430, filed on Dec. 31, 2024, which is hereby incorporated by reference in its entirety.

### TECHNICAL FIELD

This invention relates generally to refrigerated sandwiches, dough and bread formulations for refrigerated sandwiches, and more particularly to a ready-to-eat sandwich product enclosed in a tray suitable for refrigeration storage.

### BACKGROUND

Ready-to-eat or quickly prepared food has become increasingly popular with consumers over the years due to busy lifestyles and an increase in the variety of available, convenient food options. Sandwiches are a perennial favorite for lunches and snacks alike. Sandwiches are convenient and can be enjoyed at hot or cold temperatures.

Many sandwiches have their best texture and flavor when freshly prepared or when eaten within a short period of time after preparation. While sandwiches may be refrigerated before consumption, the texture of the bread can be adversely affected by moisture migration. For example, the bread may become soggy due to moisture migration from higher water activity ingredients. Also, the bread might develop a stale texture during refrigeration due to recrystallization of starches in the bread.

Conventional refrigerated sandwich products generally have a shelf life of no more than 5 to 7 days due to microbial growth (e.g., mold) and/or drying out (going stale). Even with this short shelf-life, there may be significant degradation of texture and organoleptic properties. Further, the components of the sandwich other than the bread can have a significant deleterious effect on the shelf life of the product. For example, the inclusion of ingredients with differing water activities makes extending the shelf life beyond 7 days a significant challenge due to moisture migration between components of the sandwich. At least for this reason, as well other microbial stability challenges, commercially available sandwiches are often in frozen form.

Peanut butter and jelly is a classic sandwich enjoyed by children and adults of all ages but has generally only been readily available when prepared for immediate consumption (e.g., within a few days) or in frozen form. Both the bread and peanut butter can be adversely impacted by moisture migration during storage. For example, the peanut butter may harden over time as moisture moves from the bread into the peanut butter and dilutes the oil content of the peanut butter that keeps the peanut butter soft and pliable, and the bread may harden as moisture moves out of the bread into the peanut butter.

Commercially available frozen peanut butter and jelly sandwiches include peanut butter placed on the inner surface of two slices of bread and jelly placed between the peanut butter layers. This results in a layered filling of peanut butter, jelly, and peanut butter. The peanut butter forms a barrier between the higher water activity jelly and the bread slices, which assists in reducing moisture migration from the jelly to the bread prior to freezing the product. Further, the crust of the sandwich is often removed and the edges of the bread crimped to create a seal, thereby reducing moisture migration from the external environment and the interior of the sandwich.

While freezing bread or sandwiches can significantly extend the shelf life, a frozen sandwich is less convenient for consumers. For example, a microwave might be needed to quickly thaw the sandwich. Alternatively, the consumer might need to remember to remove the sandwich from the freezer in sufficient time for it to thaw before consumption. However, thawing of frozen sandwiches can also lead to degradation in the texture of the bread, as well as provide more opportunity for moisture migration between the ingredients of the sandwich prior to consumption.

There is a need in the market for improved sandwich offerings while addressing the above-mentioned problems.

### BRIEF DESCRIPTION OF THE DRAWINGS

FIG. 1 is a diagram of a process for making an embodiment of a sandwich product.

FIG. 2 is a top perspective view of an embodiment of a tray with three cavities therein.

FIG. 3 is a bottom perspective view of the tray embodiment of FIG. 2.

FIG. 4 is a top perspective view of an embodiment of a triangular crimped sandwich.

FIG. 5 is a side view of the sandwich embodiment of FIG. 4.

FIG. 6 is a side view of an alternative sandwich embodiment.

FIG. 7 is a top perspective view of a second embodiment of a triangular crimped sandwich.

FIG. 8 is a top perspective view of an embodiment of a packaged sandwich product.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments described herein, dough formulations are provided that enable preparation of fully baked bread products with significant refrigerated shelf-life while maintaining the textural properties of the baked bread. The dough is specifically formulated so that the bread, and sandwiches made therewith, has a significantly lengthened shelf life at refrigeration temperatures. In one aspect, the packaged sandwich product has a shelf life of 30 days or more, 40 days or more, 50 days or more, 60 days or more, 70 days or more, or 80 days or more when the sandwich is stored in modified atmosphere packaging at refrigeration temperature (i.e., at 4° C.). In another aspect, the packaged sandwich product has a shelf life of up to about 90 days.

The dough formulations provided herein result in a soft crumb in the baked bread produced therefrom. Soft crumb refers to the internal texture of the baked bread. A soft crumb beneficially provides good crimpability of the bread, and the present dough formulations deliver a soft crumb that is advantageously maintained throughout the refrigerated shelf life. In some approaches, the bread product may be in the form of a sandwich product with a filling between two bread slices. In particular, the dough formulation provides a soft bread crumb and bread texture and maintains the texture of the filling for the extended shelf life without significant alteration of the water activity of the bread or filling during storage. For example, when the filling is a nut butter, the filling maintains a soft texture due to reduced moisture migration from the bread into the filling.

Also provided are ready-to-eat sandwich products, such as a nut butter sandwich product, enclosed in a formed tray suitable for refrigeration storage. The tray can be sealed with lidding and stored at refrigeration temperatures. In one aspect, the sandwich is a nut butter sandwich and has a nut butter filling between two slices or layers of bread. In some approaches, the edges of the sandwich product are crimped so that the filling is enclosed by the two slices of bread and is not visible from the outside of the sandwich. In another aspect, the packaged refrigerated sandwich product further includes a condiment, such as a jam or jelly, which may be included in a separate cavity of the formed tray in order to reduce or eliminate moisture migration between the sandwich and condiment.

### Dough Formulation

The dough formulations described herein are primarily described in terms of baker's percentages, which are weight percentages based on the weight of flour used in the formulation (such as per 100 pounds of flour). For example, for 100 pounds of flour in a recipe, 60 percent (or 60 pounds) water and 3 percent (or 3 pounds) oil would mean the addition of 60 pounds of water and 3 pounds of oil to 100 pounds of flour. Baker's percentages do not normally add up to 100 percent, but conventional weight percentages can be calculated from baker's percentages by normalizing to 100 percent once the amount of flour has been determined.

Any suitable flour may be used to form the dough. In one aspect, the flour may be a grain-based flour, including whole grain flour and refined flours, such as all-purpose flour or bread flour. Suitable flours include hard wheat, soft wheat, whole wheat, and any combination thereof. Grains may include, for example, wheat, barley, and combinations thereof. In some approaches, the flour is wheat flour. For example, flour that has been supplemented with vitamins and minerals to meet federal government standards may be used. For example, in the U.S., thiamin, riboflavin, niacin, folic acid and iron are required supplements in flour.

In some approaches, it has been found that grain-based flours including about 10% to about 14%, about 11% to about 13%, or about 12% protein by weight of the flour are particularly suitable. Generally, it has been found that inclusion of a grain-based flour with protein in these ranges are particularly suitable.

To provide a significant refrigeration shelf life while also maintaining desirable soft bread texture and filling texture, it has been found that including a combination of enzymes in the dough formulation is particularly effective. In one approach, the enzymes include a combination of (1) a maltogenic amylase and (2) an amyloglucosidase. The enzymes act on the carbohydrates in the flour in a cooperative manner to facilitate yeast fermentation, maximize bread volume, minimize crust creation, and maximize crumb softness over shelf life.

Maltogenic amylase is a member of the glycoside hydrolase family 13 of enzymes, and a member of class EC3.2.1.133. Maltogenic amylases catalyze the hydrolysis of (1,4)-α-D-glucosidic linkages in starch to generate maltose units. Maltose is formed of two glucose units. An exemplary maltogenic amylase is ESSENTIAL® Soft 2014 from Lallemand Inc. In some approaches, the maltogenic amylase is included in an amount of about 0.005% to about 1%, in another aspect about 0.01% to about 0.5%, in another aspect about 0.01% to about 0.1%, in another aspect about 0.02% to about 0.08%, and in another aspect about 0.02% to about 0.04% (percent flour basis).

Amyloglucosidases (also referred to as glucoamylases) hydrolyze carbohydrates into glucose. These enzymes also hydrolyze maltose to release glucose. An exemplary amyloglucosidase is ESSENTIAL® FSA from Lallemand Inc. In some approaches, the amyloglucosidase is included in an amount of about 0.01% to about 2%, in another aspect about 0.05% to about 1.5%, in another aspect about 0.1% to about 1%, in another aspect about 0.125% to about 0.5% (percent flour basis).

The dough formulation further includes a leavening agent, including, for example, one or more of yeast, sodium bicarbonate, monocalcium phosphate anhydrous, sodium acid pyrophosphate, sodium aluminum phosphate, sodium aluminum sulfate, dicalcium phosphate dihydrate, and glucono-δ-lactone, among others. However, for purposes of the present dough formulation, yeast is generally preferred. When the leavening agent comprises yeast, the glucose released by the action of the enzymes can then be used by the yeast during a yeast fermentation step. Fermentation and proofing steps allow the creation and release of glucose by action of the enzymes. Throughout the proofing step, the yeast continue to utilize the glucose for fermentation. Then during the baking step, the rise in temperature greatly accelerates yeast activity and glucose consumption, while deactivating the enzyme, and results in rapid evolution and expansion of carbon dioxide gas and air. The dough structure formed during this process traps the gas, thus forming the bread. Fermentation also aids in producing desirable flavors in the bread.

Any suitable form of yeast may be used, such as active dry yeast (low moisture content of about 7.5 to about 9%), instant active yeast (can be added without prior hydration), bulk yeast (similar to compressed yeast but isn't compressed into a cake form and can be interchanged with compressed yeast), compressed yeast (includes about 70% moisture and is compressed into a cake), or cream yeast (a fluid form of yeast where about 0.65 quarts of yeast is equivalent to 1 pound of compressed yeast).

In some approaches, the cream yeast is included in an amount of about 0.5% to about 5%, in another aspect about 1% to about 5%, in another aspect about 2% to about 4% (percent flour basis). If dried yeast is used instead of a cream yeast, the baker's percentage or weight is approximately halved to account for the water content of the cream yeast; likewise, the amount of water added may be increased to account for the lower water content of the dried yeast.

The dough formulation further includes a fat component. The term “fat component” includes both fat sources that are solid at room temperature (70° F.) or liquid at room temperature. Exemplary solid fats include, for example, a shortening. Suitable liquid oils include, for example, soybean, canola, cottonseed, corn, and sunflower, or any combination thereof. In some approaches, the fat component is included in an amount of about 0.5% to about 10%, in another aspect about 1% to about 8%, in another aspect about 1% to about 5%, in another aspect about 2.5% to about 3.5% (percent flour basis). In some approaches, fat components that are solid at room temperature are preferred.

The dough formulation also includes water. The amount of water should be sufficient to hydrate the flour and any other dry ingredients (e.g., salt) so that a cohesive dough can be formed. It has been found that the moisture content can be important to crimpability of the sandwich. However, inclusion of too much moisture can result in a dough that is not cohesive (i.e., falls apart). In some approaches, the water is included in an amount of about 45% to about 75%, in another aspect about 50% to about 70%, in another aspect about 55% to about 65% (percent flour basis).

In some approaches, salt may be included in the dough formulation, such as in the form of sodium chloride. In one aspect, salt may be included in an amount of about 0.1% to about 10%, in another aspect about 0.5% to about 5%, in another aspect about 0.5% to about 3% (percent flour basis). Salt may be added for multiple purposes, including for flavor, slowing down the yeast fermentation process, and for strengthening the gluten network in the dough.

In some approaches, the dough may further include one or more microbial inhibitors to delay mold and bacterial growth during the shelf life of the product. For example, suitable microbial inhibitors include calcium propionate, sodium propionate, potassium sorbate, sorbic acid, nisin, natamycin, sodium benzoate, and benzoic acid, among others. In one aspect, the microbial inhibitor is calcium propionate. The microbial inhibitor may be included in the dough and/or applied to the exterior surfaces of the bread product after baking. Other microbial inhibitors include sorbic acid, which is a growth inhibitor for molds, yeasts and bacteria. In one approach, encapsulated sorbic acid is used. Encapsulated sorbic acid results in delayed release and dissolution of the sorbic acid in the dough so that the sorbic acid doesn't adversely affect desirable yeast fermentation. In one aspect, microbial inhibitor may be included in an amount of about 0.01% to about 1%, in another aspect about 0.05% to about 0.8%, in another aspect about 0.1% to about 0.3% (percent flour basis).

Exemplary dough formulations are provided:

| | Amount | | |
|---|---|---|---|
| | | Baker's % | Baker's % |
| | Baker's % | Range | Range |
| Ingredient | Range | (Preferred) | (More Preferred) |
| Required Ingredients: | | | |
| Flour | 100 | 100 | 100 |
| (10.5-11% protein) | | | |
| Water* | 45-75 | 50-70 | 55-65 |
| Leavening agent* | 0.5-5 | 1-5 | 2-4 |
| Maltogenic amylase | 0.005-1 | 0.01-0.5 | 0.01-0.1 |
| Amyloglucosidase | 0.01-2 | 0.05-1.5 | 0.1-1 |
| Fat component | 0.5-10 | 1-8 | 1-5 |
| Preservative | 0.1-1 | 0.05-0.8 | 0.1-0.3 |
| Salt | 0.1-10 | 0.5-5 | 0.5-3 |
| Optional Ingredients: | | | |
| Dough conditioner | 0.1-1.0 | 0.2-0.8 | 0.3-0.7 |
| Vital wheat gluten | 0-3 | 0-2 | 0.5-2 |

*Amounts of leavening agent and water are based on an amount of cream yeast and can be adjusted for a dried leavening agent

In some approaches, the dough is specifically formulated without added sugar, and the only sugar in the dough is that produced by action of the enzymes. As used herein, “without added sugar” means that a caloric sweetener is included at 3% or less, 2% or less, 1% or less, 0.5% or less, 0.1% or less, or 0% (% flour basis). As used herein, caloric sweetener means sucrose, fructose, maltose, galactose, glucose, lactose, and any combinations thereof, whether included in syrup, granulated, or other form.

### Optional Ingredients

Any combination of one or more of the above optional ingredients may be included in combination with the required ingredients. Though not required to achieve a desirable soft texture during the refrigerated shelf life of the bread, additional ingredients can be added that do not adversely impact the shelf life of the bread, such as flavorings or colorants. In some approaches, one or more additional ingredients may be included that further enhance textural characteristics, flavor, or microbial stability over the shelf life of the product.

In some approaches, additional gluten protein may be included in the dough formulation, such as in the form of vital wheat gluten. There can be natural variation in the gluten content of flour. Therefore, to compensate for a flour having a lower gluten content, additional gluten protein can be added to increase the total amount of gluten in the dough. The amount of gluten in the dough influences the elasticity of the dough and the strength of the dough structure. It has also been found that higher amounts of gluten can lengthen the shelf stability of the baked bread at refrigeration temperatures, as the gluten content contributes to maintaining softness of the bread during its shelf life. In some approaches, gluten protein is added (separate from any gluten in the flour) in an amount of about 0% to about 3%, in another aspect 0% to about 2%, in another aspect about 0.5% to about 2%, and in another aspect about 1% to about 2% (percent flour basis). The amount of additional gluten added depends, in part, on the amount of gluten in the flour component of the dough. For example, use of a flour with a lower gluten content can be compensated for by adding higher amounts of gluten as a separate ingredient or by combining the lower gluten flour with a higher gluten flour.

In some approaches, dough conditioners may be included in the dough formulation. Dough conditioners contribute to bread crumb structure and dough stability. In one aspect, dough conditioner may be included in an amount of about 0.1% to about 1%, in another aspect about 0.2% to about 0.8%, in another aspect about 0.3% to about 0.7%, and in another aspect about 0.4% to about 0.6% (percent flour basis). Dough conditioners include, for example, diacetyl tartaric acid esters of mono- and diglycerides. One particularly useful dough conditioner is FERMAID® SSR from Lallemand Inc., which is an inactive yeast product that acts as a reducing agent that improves dough consistency (extensibility and machinability) and reduces mixing requirements. FERMAID® SSR contains glutathione and heat-deactivated Saccharomyces cerevisiae that has been roller dried and ground.

### Dough Processing

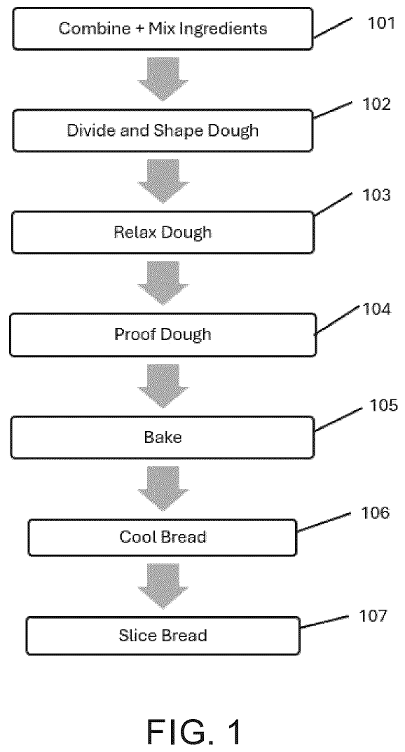

In one approach, the dough may prepared by mixing the dough ingredients using conventional equipment. One exemplary process 100 is outlined in FIG. 1. The ingredients except the salt and antimicrobial are first added and mixed in step 101, followed by addition of the salt and antimicrobial, such as about 5 to about 8 minutes later to form a dough. The dough should be at about 78 to about 82° F. The dough is then divided and shaped in step 102 into dough portions (generally about 48 ounces). After shaping, the dough is allowed to relax for about 3 to 6 minutes in step 103, such as at ambient temperature, which in some cases may be somewhat higher than typical room temperature and relative humidity due to the proximity of baking equipment and ovens. The dough portions are then proofed for about 40 to about 60 minutes at about 80 to about 85 percent relative humidity and a temperature of about 95 to about 98° C. in step 104. The proofed dough is then baked at a temperature of about 420° F. to about 450° F. for about 18 to about 22 minutes in step 105 to form a fully baked bread. The baked bread is then allowed to cool in step 106, such as to below 100° F., in another aspect below 95° F., before slicing in step 107. The bread can be sliced to any desired thickness and using any conventional slicing equipment.

Filling can then be applied to the bread slices. Non-limiting examples of sandwich fillings include almond butter, sunflower butter, peanut butter, cashew butter, sunflower seed butter, hazelnut butter, or any combination thereof. For example, when a nut or seed butter is used as a filling, about 12 to about 15 grams nut butter can be applied to bread slices. The filling may be deposited by any suitable equipment. After the filling has been deposited on the bread slices, a bread slice is applied on top of the filling to form a sandwich configuration.

The sandwich may be formed in any desired shape. For example, the sandwich may be provided in a triangular, rectangular, square, oval, or circular shape. The precise shape isn't particularly limited except that there may be advantages to selecting specific shapes depending on the shape of the tray that is selected. For example, in one approach, the sandwich is in a triangular format, making it easy to dip ends of the sandwich into a condiment. In contrast, a sandwich in a circular format is less convenient to dip into a condiment because the sandwich has no distinct corners.

At least in some approaches, the sandwich is further processed by crimping or pinching the edges of the bread to form a sandwich with sealed edges. In one aspect, the crimping or pinching is carried out inward of the outer edges of the bread such that any crust portions of the bread are located outside of the crimped edges and can be removed from the sandwiches. Generally, any suitable crimping equipment may be used so long as the equipment forms a relatively tight crimp that keeps the two bread portions adhered together along the entire perimeter of the product throughout the shelf life of the product. Any gaps in the crimping may allow undesirable moisture migration between the atmosphere and the filling, and may adversely affect the texture of the bread slides and/or the filling.

Once the crimped sandwiches have been formed, the sandwiches may be filled into any suitable packaging, preferably under an inert gas (e.g., nitrogen) or inert gas-flushed atmosphere, and sealed. The sandwiches may then be stored in refrigeration conditions for the shelf life of the product.

The sandwich may be packaged in any suitable packaging, such as a tray or pouch. In some approaches, the sandwich is packaged under inert gas and/or inert gas-flushed conditions. The packaging may be formed from polymeric films, such as polyethylene terephthalate (PET), foil, paperboard, or molded fiber. In some embodiments, the tray is a thermoformed plastic tray, which may be formed of, for example, a PET material.

Trays further include a lidding material, such as a foil, polymeric film, or polymeric lid. Oxygen and/or moisture barrier layers or coatings may be applied to the packaging materials as needed to provide necessary barrier properties for product shelf life.

In one embodiment, the packaged sandwich product includes a tray with a flexible film sealed to a portion thereof to contain the sandwich product. By one approach, the tray may include a first cavity (or well), a second cavity (or well) adjacent the first cavity, and a peripheral flange. By one approach, the tray may include a third cavity (or well). The peripheral flange surrounds the first and second (and optionally third) cavities that are joined to form a generally rectangular tray when viewed from above. The peripheral flange may be generally rectangular in shape with two lengthwise sides and two end sections.

In some embodiments, the cavities of the packaged food product may include a base and a sidewall with a vertical portion below the peripheral flange and a sloped portion connecting the vertical portion with the base. In use, this sloped sidewall portion may permit relatively easy removal of the sandwich product within the cavity.

To provide a hermetically sealed package, the tray may have a flexible film attached to the peripheral flange. In one embodiment, the flexible film has an upper surface and a lower surface, the lower surface may have a sealant disposed thereon, such that the lower surface of the flexible film is hermetically sealed to the upper flange to seal a sandwich product (and any condiments) within the tray.

In some embodiments, the packaged sandwich product comprises a formed tray with a crimped sandwich sealed within one or more cavities of the formed tray using a flexible film. The crimped sandwich may be, for example, a nut-butter sandwich formed of two slices of bread and a nut-butter spread therebetween. To improve the integrity of the seal between the flexible film and the formed tray, a sealant may be disposed on a lower side of the flexible film. A flexible film and/or sealant that are compatible with the formed tray material may also help to further improve the seal integrity. In one approach, the crimped sandwich has a generally triangular shape. One of more crimped sandwiches may be included in the formed tray, and each of the crimped sandwiches may be provided in separate cavities of the formed tray. Further, at least in some approaches, a condiment, such as a jam or jelly, may be provided in an additional cavity of the formed tray.

In some approaches, the tray or well(s) of the tray may have a shape that is complementary to the shape of the sandwich itself. For example, one or more wells of the tray that houses the sandwich may be of a similar shape to that of the sandwich. For instance, a triangular sandwich may be placed in a triangular well of a tray, or a circular sandwich may be placed in a round well of a tray.

For trays holding multiple sandwiches, it has been found to be beneficial to house each sandwich in separate wells of the tray. For example, a tray might have two wells and house two sandwiches, with one sandwich in each well. It has been found that having two sandwiches in the same well can lead to the bread portions of the sandwiches sticking to one another.

Moisture migration is particularly problematic when sandwiches include components having different water activities. For example, a traditional peanut butter and jelly sandwiches includes a layer of jelly directly on a layer of peanut butter between two slices of bread. The sandwich bread may have a different water activity from the peanut butter, and each may have a different water activity from a fruit-based jelly. Typically, peanut butter will have the lowest moisture content (e.g., peanut butter generally has a water activity of about 0.2 to about 0.36), bread has a higher moisture content than the peanut butter (e.g., bread generally has a water activity of about 0.88 to about 0.96), and a fruit jelly has the highest moisture content of both the bread and peanut butter (e.g., with a water activity of greater than about 0.96). Over time, moisture will migrate from the highest water activity component to lower water activity components, which can lead to significant deterioration of the mouthfeel, texture, and microbial stability of the sandwich components.

Therefore, it has been found to be advantageous to include a condiment in a separate well of the sandwich tray so that the sandwich(es) and condiment are kept separate during refrigeration storage. Non-limiting examples of dips include fruit-based dips, such as jam, jelly, preserve, marmalade, as well as other dips, including chocolate, honey, apple butter, honey, or a combination thereof. By separately housing the condiment in its own well of the tray, moisture migration between the condiment and the sandwich can be reduced or eliminated so that the shelf life of both the sandwich and condiment can be lengthened and without adversely impacting the textural and/or flavor attributes of each of the food components in the tray. The consumer can then add the condiment to the sandwich in any desired fashion, such as by dipping the sandwich into the condiment in the tray or by spreading the condiment on the sandwich, such as with a knife.

In some approaches, a moisture barrier may be included. In one aspect, a barrier layer, such as in the form of a coating, may be applied to the bread before applying the filling to the bread. However, such a coating is generally not required to achieve the refrigerated shelf life of the baked bread provided by the dough formulation described herein. However, if the filling has a higher water activity than a nut butter, or if a fruit-based condiment is applied to the bread of the sandwich, such a moisture barrier may be advantageous. Any moisture barrier known in the art may be used, if desired. At least in some approaches, the sandwich specifically does not include a moisture barrier layer or coating on any component of the sandwich.

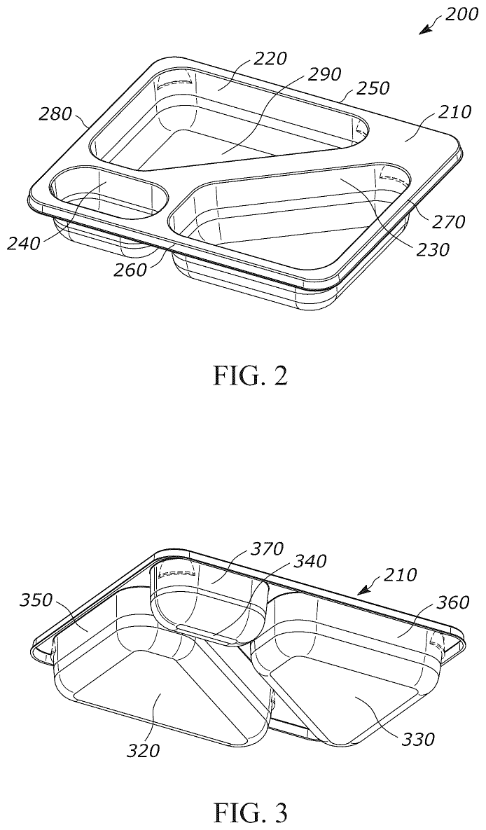

Turning now to the figures, an exemplary formed tray for the refrigerated sandwich product and condiment is illustrated in FIGS. 2 and 3. FIG. 2 illustrates a three-cavity embodiment of the formed tray 200. In addition to the three-cavity embodiment shown herein, formed trays with fewer cavities or additional cavities may be used. For example, in some approaches, formed trays may include one, two, four, or five cavities. In addition, some of the trays may have a structure that allows one to separate one or more cavities from each other, such as, for example, a line of weakness, score, or set of perforations in the formed tray and any lidding atop the formed tray.

As illustrated in FIG. 2, the formed tray 200 includes a peripheral flange 210, a first cavity 220, a second cavity 230, and a third cavity 240. Cavities 220, 230 are generally triangular in shape and sized to hold triangular sandwiches. Cavity 240 is smaller and generally oval in shape and sized to hold a condiment. The peripheral flange 210 surrounds the three cavities 220, 230, 240 of the formed tray 200 and includes rounded corners. The peripheral flange 210 is generally a flat surface to which a film may be sealed, secured, adhered, or otherwise attached to hermetically seal the sandwich product and condiment in the cavities. Cavities 220, 230, 240 are recessed below the peripheral flange 210.

In some embodiments, the peripheral flange 210 defines an upper surface of the formed tray and surrounds the outer periphery of the tray. In some configurations, the peripheral flange 210 is sufficiently flat to permit a film to be sealed or otherwise attached thereto. By one approach, the peripheral flange may be generally rectangular in shape, including two lengthwise sides 250, 260 and two ends 270, 280.

The cavities 220, 230 of the formed tray are recessed below the peripheral flange 210. The formed tray includes a first cavity 220 and a second cavity 230 of roughly equal sizes, and a third cavity 240 of smaller size. Cavities 220, 230 have a generally triangular shape and cavity 240 has a generally oval shape. Though the cavities 220, 230, 240 are depicted in FIG. 2 as having the same depth, different depths may be used. For example, if a small quantity of condiment is desired for a particular type of sandwich, a cavity with a lesser depth may be warranted.

As illustrated in FIG. 3, each cavity may further include a base portion 320, 330, 340 and sidewall 350, 360, 370 extending downwardly from the peripheral flange 210 to the base portion 320, 330, 340. Base portions 320, 330 of the first and second cavities include a planar portion, which forms a bottom surface of the tray in some configurations. In other configurations, the base portion may be arcuate to assist with removal of the food product from within the cavity. Base portion 340 of the third cavity includes a much smaller planar portion in some configurations. In other configurations of the third cavity (or any condiment cavity), a larger planar portion may be used, or the base portion may not include any planar portion at portion.

The sidewall 350, 360, 370 forms at least a portion of the cavity and may be straight or curved, or may include both straight and curved portions. A curved portion of sidewall 350, 360, 370 adjacent base portion 320, 330, 340 may assist with the removal of the food product from the cavity. Particularly for a cavity containing a condiment, a curved portion of the sidewall allows a consumer to dip a sandwich into the condiment and slide the condiment from the base of the cavity up along the sidewall of the cavity to apply the condiment to the sandwich.

The formed tray 100 may be formed of various materials such as high-density polyethylene, low-density polyethylene, polyester, polypropylene, polyethylene terephthalate, glycol-modified polyethylene terephthalate, recycled polyethylene terephthalate, polyvinylidene chloride, or polystyrene. In some examples, the tray may be a thermoformed or blown tray. In other examples the tray may be injection molded.

The thickness of the formed tray is not believed to be particularly limited.

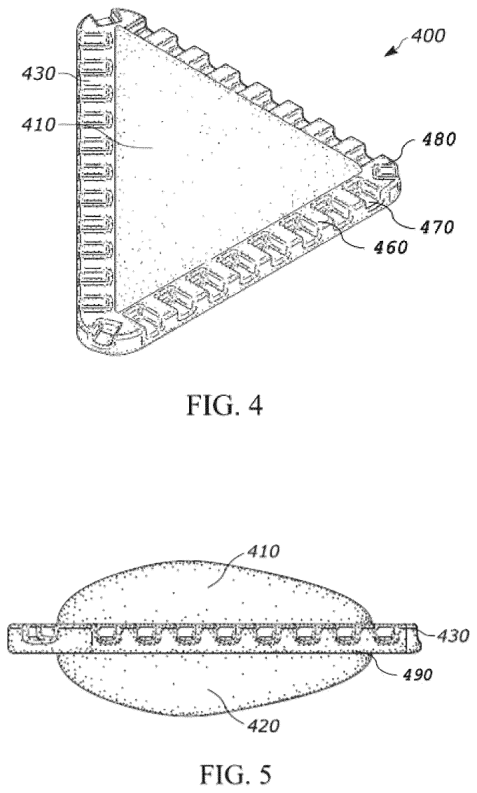

FIGS. 4-5 illustrate an embodiment of a sandwich 400. Sandwich 400 has a generally triangular shape. As shown in FIG. 5, sandwich 400 has an upper bread portion 410 and lower bread portion 420. The edges 430 of the sandwich are crimped and form a sealed perimeter around the sandwich 400, fully enclosing a filling therein. The crimp has a stepped configuration. The stepped configuration includes a repeating pattern of alternating ridges 460 and indentations 470. The ridges 460 are formed as arcuate or linear portions between adjacent indentations 470. The indentations 470 are formed as recesses extending downward from the upper bread portion 410 toward the lower bread portion 420. The indentations 470 are spaced at regular intervals around the edges 430. In some examples, the crimped corners 480 include indentations 470. In some examples, the bottom portion 490 of the crimp has a generally flat surface. It is presently thought that the configuration of the crimp assists with maintaining the crimp during storage so as to avoid leakage of the contents of the sandwich.

The height of the upper bread portion 410 is approximately the same as the height of lower bread portion 420, as measured from the center point of the crimped edge.

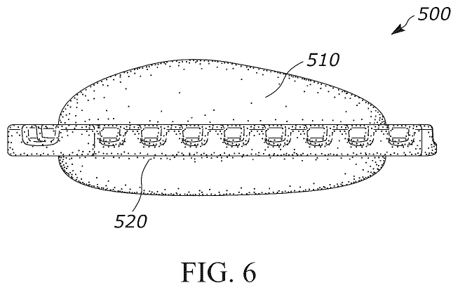

The amount of filling in the sandwich can vary. FIG. 6 shows an alternative embodiment of a sandwich 500. There, sandwich 500 has an upper bread portion 510 and lower bread portion 520. The height of the upper bread portion 510 is twice the height of lower bread portion 520.

Though the sandwiches of FIGS. 4-6 are shown with a generally triangular shape, other sandwich shapes may also be used.

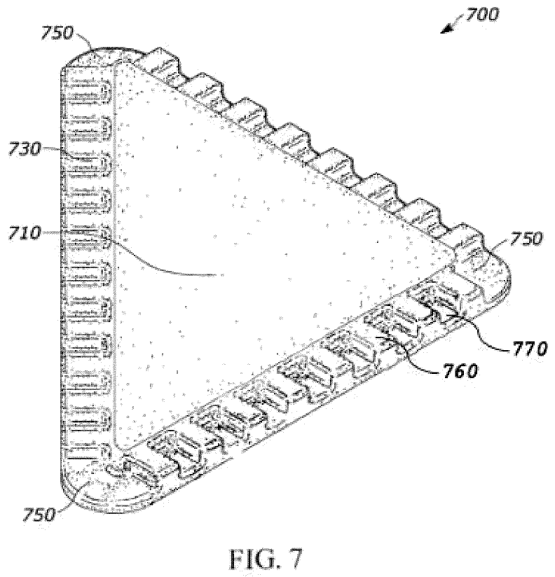

FIG. 7 illustrates a further embodiment of a sandwich 700 with an alternate crimp configuration. Sandwich 700 has a generally triangular shape. As shown in FIG. 7, sandwich 700 has an upper bread portion 710 and a lower bread portion (not shown). The edges 730 of the sandwich are crimped and form a sealed perimeter around the sandwich 700, fully enclosing a filling therein. The crimp has a stepped configuration. The stepped configuration includes a repeating pattern of alternating ridges 760 and indentations 770. The ridges 760 are formed as raised arcuate or substantially linear portions between adjacent indentations 770. The indentations 770 are formed as recesses extending downward from the upper bread portion 710 toward the lower bread portion. The crimped corners 750 include wider flat portions than shown for the embodiment of FIGS. 4-6. The crimped corners 750 are formed at a depth approximately the same as the depth of the indentations 770. It is presently thought that such wide flat portions in the crimp configuration assist with maintaining the crimp during storage.

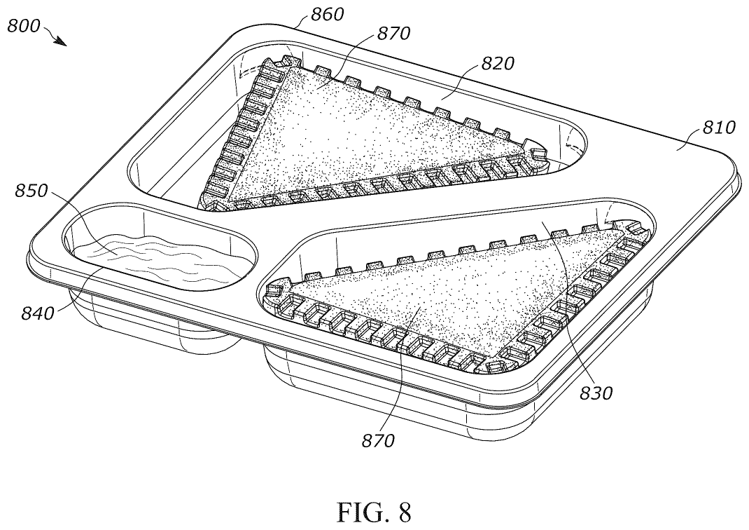

A packaged sandwich product 800 is shown in FIG. 8. More specifically, a sandwich 870 is disposed within each of the cavities 820 and 830 of tray 860, and a condiment 850 is disposed within cavity 840 of tray 860. A flexible film (not shown) or other lidding may be disposed on the peripheral flange 810 of tray 860 to seal the sandwiches and condiment in the formed tray for refrigeration storage.

The flexible film or other lidding of the packaged food product provides a barrier to protect the quality and integrity of the food product disposed in the formed tray. The flexible film may be one or a combination of polymer materials. For example, the flexible film may include polyester, polyvinyl alcohol, ethylene vinyl alcohol, polyvinylidene chloride, polypropylene, polyethylene, and/or nylon. The flexible film may be a single layer or multilayer film. To improve the seal integrity of the final packaged sandwich product, the flexible film may be formed from a material that is compatible with the tray material. A flexible film material that is compatible with the composition of the formed tray will help to bond the flexible film to the formed tray in order to effectively seal the flexible film to the formed tray.

The flexible film includes an upper surface and a lower surface. The lower surface of the flexible film may be sealable to the peripheral flange of the tray, optionally in a hermetic manner. In some examples, the flexible film may further include a heat seal coating sealant layer, a cold seal adhesive, or a pressure sensitive adhesive. For example, a pressure sensitive adhesive may be disposed on the lower surface of the flexible film in order to seal the flexible film to the peripheral flange of a tray. In one example, a cold seal adhesive may be disposed on the lower surface of the flexible film and on the peripheral flange of the formed tray to bond the flexible film to the formed tray. In another example, the lower surface of the flexible film may include a heat and pressure-activated sealant that attaches to the peripheral flange of a tray via heat and pressure. In some embodiments, the flexible film may be sealed to the formed tray under vacuum with a nitrogen atmosphere. In some embodiments the flexible film is peelable to create a final product with an easy-open package seal.

In one example, the flexible film may be clear so that the contents of the tray are visible after the flexible film has been sealed to the tray. In other examples, the film may be matte, colored, or white. By some approaches, the film may also be printable by methods, such as offset or screen-printing, allowing the flexible film to incorporate graphics. For example, the flexible film may include ingredient lists, nutritional information, and/or instructions for storing or eating the food product.

A final packaged sandwich product may be stored at refrigerated temperatures until use. In one embodiment, the c40 days or more, 50 days or more, 60 days or more, 70 days or more, or 80 days or more when the sandwich is stored in modified atmosphere packaging at refrigeration temperature (i.e., at 4° C.). In another aspect, the packaged sandwich product has a shelf life of up to about 90 days.

The following example is intended to illustrate the dough and sandwich products and methods provided herein and not to limit or otherwise restrict the disclosure. Unless indicated otherwise, all parts, ratios, and percentages are based on weight.

### EXAMPLE

A bread dough was made using the following formulation:

Amount

| Ingredient | Wt. % | Baker's % |
|---|---|---|
| Wheat flour | 59.03 | 100 |
| (10.5-11% protein) | | |
| Water | 36.89 | 62.545 |
| Cream yeast | 3.54 | 3.182 |
| Dough conditioner | 0.30 | 0.5 |
| (ESSENTIAL ® | | |
| Total 2009) | | |
| Maltogenic amylase | 0.12 | 0.2 |
| (ESSENTIAL ® | | |
| Soft 2014) | | |
| Amyloglucosidase | 0.04 | 0.06 |
| (ESSENTIAL ® | | |
| FSA 2013) | | |
| Inactive yeast | 0.09 | 0.15 |
| (Fermaid SSR) | | |
| Soybean oil | 1.77 | 3.0 |
| Salt | 1.03 | 1.75 |
| Encapsulated sorbic acid | 0.06 | 0.1 |
| Calcium propionate | 0.27 | 0.4 |
| Vital wheat gluten | 1.18 | 2.0 |
| | 100.0 | |

The ingredients except the salt and antimicrobial were added and mixed using a commercial bakery mixer. The salt and antimicrobial were then added about five minutes after the initial ingredients and mixed to form the dough. The dough should be at about 78 to about 82° F. The dough was then divided and shaped into dough portions (generally about 48 ounces). After shaping, the dough was allowed to relax for about 3 to 6 minutes. The relaxation step was carried out at an uncontrolled temperature. Due to the proximity of mixers, proofing boxes, and ovens, the temperature was at a relatively higher than typical room temperature and higher relative humidity. The dough portions were then proofed for about 40 to about 60 minutes at about 80 to about 85 percent relative humidity and a temperature of about 95 to about 98° C. The proofed dough was then baked at a temperature of about 420° F. to about 450° F. for about 18 to about 22 minutes in a commercial oven to form a fully baked bread. The baked bread was allowed to cool, such as to below 100° F., in another aspect below 95° F., before slicing into slices of about 12.7 mm thick.

Peanut butter (about 13.7 grams) was then applied to the center of half of the bread slices. Each of the slices with peanut butter was then topped with one of the remaining plain slices of bread to form a peanut butter sandwich. A crimping tool was then used to form a crimped edge inward of the bread crumb around the entire sandwich. The crimping closed the edges of the sandwich, and no peanut butter was visible after crimping.

The crimped sandwiches were packaged in one well of a tray. A strawberry fruit spread was placed in a separate well in about half of the trays, and a grape fruit spread was placed in a separate well in the other half of the trays. The trays were sealed with a film with modified atmosphere.

The crimped sandwiches in the trays were then subjected to a refrigeration shelf-life study when stored at 4° C. and 7° C. The testing demonstrated acceptable microbial stability throughout the 16-week testing period.

The sandwiches were also evaluated for taste and texture by a group of adult testers over a 15-week testing period. At each weekly time point, sandwiches were removed from refrigeration storage and evaluated at the same ambient conditions. The attributes of the bread component were separately evaluated from the peanut butter attributes. The fruit spread performance was also separately evaluated. The overall product was also evaluated

For the bread component, the testing data demonstrated that the bread had a steady performance over the refrigeration shelf life. The crimp failed on some of the samples that caused lower quality assessment by the tasters for some samples.

For the peanut butter component, overall, the tasters found that the peanut butter began to have a drier texture around 50 days. However, the slightly drier texture was preferred by the youth testers, who preferred when the peanut butter had a less coating mouthfeel. The time point most preferred by the youth testers was 77 days.

For the fruit spread component, the tasting results demonstrated that the fruit spread had good flavor and texture throughout the 15-week period. There were negligible textural changes through the shelf life study.

For the overall product performance, the tasting results from the youth testers in particular demonstrated that the 77-day sample matched or even surpassed the 27-day sample due to balanced texture and overall experience. The 90-day sample performed more poorly, with the youth testers reporting that the texture was dry and dense.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

The description is not to be taken in a limiting sense but is made merely for the purpose of describing the general principles of exemplary embodiments. Reference throughout this specification to “one embodiment,” “an embodiment,” “some embodiments,” “an implementation,” “some aspects,” “some approaches,” or similar language means that a particular feature, structure, or characteristic described in connection with the embodiment is included in at least one embodiment of the present invention. Thus, appearances of the phrases “in one embodiment,” “in an embodiment,” “in some embodiments,” “in some aspects,” “in some approaches,” and similar language throughout this specification may, but do not necessarily, refer to the same embodiment.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A refrigerated sandwich comprising a filling and a baked bread component, the baked bread component having a top bread portion and a bottom bread portion in a stacked configuration and the filling located between the top and bottom bread portions, each bread portion having an outer perimeter edge and the bread portions pinched together along the outer perimeter edges to enclose the filling therebetween,
wherein the baked bread component is prepared from a dough comprising flour and a leavening agent, and, in baker's percentages based on the flour content, at least the following ingredients: about 0.005% to about 1% maltogenic amylase;
about 0.01% to about 2% amyloglucosidase;
about 45% to about 75% water; and
about 0.5% to about 10% fat.

2. The refrigerated sandwich product according to claim 1, wherein the filling is a nut butter filling.

3. The refrigerated sandwich product according to claim 1, wherein the dough comprises flour and, in baker's percentages based on the flour content, at least the following ingredients:
about 0.01% to about 0.5% maltogenic amylase;
about 0.05% to about 1.5% amyloglucosidase;
about 50% to about 70% water; and
about 1% to about 8% % oil.

4. The refrigerated sandwich product according to claim 1, wherein each bread portion has an outer perimeter edge in the shape of a triangle.

5. The refrigerated sandwich product according to claim 1, wherein the sandwich product does not include a fruit-based condiment.

6. The refrigerated sandwich product according to claim 1, wherein the dough includes 0 to less than about 1% percent added sugar.

7. The refrigerated sandwich product according to claim 1, wherein the leavening agent is yeast.

8. A packaged refrigerated sandwich product comprising:
a formed tray comprising at least one cavity and an upper peripheral flange;
a sandwich disposed within the at least one cavity; and
a lidding material attached to the upper peripheral flange to enclose the sandwich in the formed tray,
wherein the sandwich comprises a filling and a baked bread component, the baked bread component having a top bread portion and a bottom bread portion in a stacked configuration and the filling located between the top and bottom bread portions, each bread portion having an outer perimeter edge and the bread portions pinched together along the outer perimeter edges to enclose the filling therebetween,
wherein the baked bread component is prepared from a dough comprising flour and a leavening agent and, in baker's percentages based on the flour content, at least the following ingredients:
about 0.005% to about 1% maltogenic amylase;
about 0.01% to about 2% amyloglucosidase;
about 45% to about 75% water; and
about 0.5% to about 10% fat.

9. The packaged refrigerated sandwich product according to claim 8, wherein the lidding material is a flexible film hermetically sealed to the upper peripheral flange of the formed tray.

10. The packaged refrigerated sandwich product according to claim 8, wherein the formed tray further comprises a second cavity with a condiment disposed therein.

11. The packaged refrigerated sandwich product according to claim 8, wherein the formed tray comprises a first and second cavity each with a sandwich disposed therein, and a third cavity with a condiment disposed therein.

12. The packaged refrigerated sandwich product according to claim 8, wherein the sandwich does not include a fruit-based condiment enclosed by the pinched perimeter edges of the first and second bread portions.

13. The packaged refrigerated sandwich product according to claim 8, wherein the dough includes 0 to less than about 1% percent added sugar.

14. The packaged refrigerated sandwich product according to claim 8, wherein the filling is a nut butter filling.

15. The packaged refrigerated sandwich product according to claim 14, wherein the filling is peanut butter.

16. The packaged refrigerated sandwich product according to claim 10, wherein the condiment is a fruit jelly or jam.

17. The packaged refrigerated sandwich product according to claim 8, wherein the sandwich has an outer perimeter edge in the shape of a triangle.

18. The packaged refrigerated sandwich product according to claim 8, wherein the leavening agent is yeast.
